(19) United States
(12) Patent Application Publication
(10) Pub. No.: US 2015/0277768 A1
(43) Pub. Date: Oct. 1, 2015

(54) RELOCATING DATA BETWEEN STORAGE ARRAYS

(71) Applicant: EMC Corporation, Hopkinton, MA (US)

(72) Inventors: Chris You Zhou, Shanghai (CN); Feng Guo, Shanghai (CN); Feng Zhang, Shanghai (CN); Yinlong Lu, Shanghai (CN); Jie Zeng, Shanghai (CN); Peter Shuai Huang, Shanghai (CN)

(21) Appl. No.: 14/669,437

(22) Filed: Mar. 26, 2015

(30) Foreign Application Priority Data
Mar. 28, 2014 (CN) 201410135582.4

(51) Int. Cl. G06F 3/06

(52) U.S. Cl. CPC G06F 3/061; G06F 3/0689; G06F 3/0665; G06F 3/0653; G06F 2003/0692

(57) ABSTRACT

A method and apparatus for automatically relocating data in a plurality of storage arrays. The method may comprise obtaining feature information of a plurality of storage devices included in the plurality of storage arrays, wherein the plurality of storage devices are grouped into a plurality of storage tiers based on the feature information; obtaining location information of the plurality of storage devices, the location information including a storage tier and a storage array at which a respective storage device is located; monitoring an access status of data stored in the plurality of storage devices; and based on the access status, the feature information and the location information, automatically generating a data moving plan that indicates a target location to which the data is to be moved. Data may automatically move between different storage tiers and across different storage arrays, without being limited within a certain storage array.

### RELATED APPLICATIONS

This application claims priority from Chinese Patent Application Number CN201410135582.4filed on Mar. 28, 2014 entitled “METHOD AND APPARATUS FOR AUTOMATICALLY RELOCATING DATA BETWEEN STORAGE ARRAYS” the content and teachings of which is herein incorporated by reference in its entirety.

### FIELD OF THE INVENTION

Embodiments of the present disclosure relate to a data storage.

### BACKGROUND OF THE INVENTION

Based on characteristics such as performance, cost, capacity, etc., a storage device may comprise a Solid State Disk (SSD), a Fiber Channel (FC) disk, a Serial Advanced Technology Attachment (SATA) disk, a Serial Attached Small Computer System Interface (SCSI) (SAS) disk, etc. In these storage devices, the input/output (I/O) delay of SSD is minimal, but the price thereof is relatively expensive; and the I/O performance of the SATA disk is relatively poor.

In view of some of the above characteristics of the storage device, it may be generally desired that the more accessed and/or active data, such as log data, are stored in a high-performance storage device such as the SSD, while the relatively less accessed and/or inactive data is stored in a low-performance storage device such as the SATA disk. The so-called storage tiering technique may be based on the above technology, that is, data being generally stored in the most appropriate storage device. With this technique, it becomes possible to improve the storage performance while reducing Total Cost of Ownership (TCO), thereby meeting growing storage requirements.

As the scale of the storage system is gradually increased, the storage performance and TCO problems are becoming more and more acute. For example, a storage system may include a number of storage arrays, and each storage array may include a number of storage devices. If all or most of the data is stored in a storage device with a relatively good I/O performance, although a very good response performance can be provided for data access, the data that are less accessed or almost never accessed will then end up wasting high cost storage resources. On the contrary, if a number of storage devices with poor performance are used considering the cost efficiency, the response performance of data access provides relatively poor satisfaction.

In the complex storage system, if the storage tiering operation is executed by manual management, e.g. the data with different access requirements are migrated manually between storage devices with different performances, then it may be very time consuming due to the too large amount of data and may also require a large number of human resources.

### SUMMARY OF THE INVENTION

In order to solve the above and other potential problems, embodiments of the present disclosure provide a solution for implementing automatic storage tiering in a complex storage system including a plurality of storage arrays, by preferably automatically implementing a storage tiering in a complex storage system that comprises a plurality of storages

It may be understood by the following description that according to embodiments of the present disclosure, data may automatically move between different storage tiers and across different storage arrays, without being limited within a certain storage array, thereby not only enabling both of improvement of storage performance and reduction of TCO, but also avoiding a waste of time and human resources.

### BRIEF DESCRIPTION OF THE ACCOMPANYING DRAWINGS

Features, advantages and aspects of respective embodiments of the present disclosure will become more apparent by making references to the following detailed descriptions in conjunction with the accompanying drawings. In the accompanying drawings, the same or similar references refer to the same or similar elements, in which:

FIG. 1 is a schematic diagram of an exemplary system in which embodiments of the present disclosure may be implemented;

FIG. 2 illustrates an exemplary flowchart of a method for automatically relocating data in a plurality of storage arrays according to one embodiment of the present disclosure; and

FIG. 3 illustrates an exemplary block diagram of an apparatus for automatically relocating data in a plurality of storage arrays.

### DETAILED DESCRIPTION

Embodiments of the present disclosure relate to data storage, and more specifically to automatic data relocation between storage arrays. Embodiments of the present disclosure will be described in detail with reference to the accompanying drawings. Although some embodiments of the present disclosure have been displayed in the accompanying drawings, it should be understood that the present disclosure can be implemented in various other forms, but not strictly limited to embodiments described herein. On the contrary, these embodiments are provided to make the present disclosure understood more thoroughly and completely. It should be understood that the accompanying drawings and embodiments of the present disclosure are merely for illustration, rather than being read as a limitation on the scope of the present disclosure.

Generally speaking, all terms used herein should be understood according to their general meanings in the art unless otherwise explicitly stated. All mentioned “a/an/the/said element, device, component, apparatus, unit, step, etc.” should be construed as at least one instance of the above element, device, component, apparatus, unit, step, etc., and it is not excluded to comprise a plurality of such elements, devices, components, apparatuses, units, steps, etc., unless otherwise explicitly stated.

Various embodiments of the present disclosure will be described below in detail by examples in conjunction with the accompanying drawings.

According to a first aspect of the present disclosure, there is provided a method for automatically relocating data in a plurality of storage arrays that include a plurality of storage devices. The method comprises: obtaining feature information of the plurality of storage devices, wherein the plurality of storage devices are grouped into a plurality of storage tiers based on the feature information; and obtaining location information of the plurality of storage devices, the location information including a storage tier and a storage array where a respective storage device is located. The method further comprises: monitoring an access status of data stored in the plurality of storage devices; and based on the access status, the feature information, and the location information, generating a data moving/movement plan that indicates a target location to which the data may be moved. In one embodiment, the step of generating a data moving plan is performed automatically.

According to the second aspect of the present disclosure, there is provided an apparatus for automatically relocating data in a plurality of storage arrays that include a plurality of storage devices. The apparatus comprises: a feature obtaining unit configured to obtain feature information of the plurality of storage devices, wherein the plurality of storage devices are grouped into a plurality of storage tiers based on the feature information; and a location obtaining unit configured to obtain location information of the plurality of storage devices, the location information including a storage tier and a storage array where a respective storage device is located. The apparatus further comprises: a monitoring unit configured to monitor an access status of data stored in the plurality of storage devices; and a moving plan generation unit configured to, based on the access status, the feature information, and the location information, generate a data moving/movement plan that indicates a target location to which the data is to be moved. In one embodiment, the step to generate a data moving plan is performed automatically. In yet a further embodiment, the feature obtaining unit, the location obtaining unit, the monitoring unit and a moving plan generation unit may all be combined into a single configuration unit which can collectively perform individual tasks of each of these separate units in a required order to perform automatic data relocation between storage arrays.

According to the third aspect of the present disclosure, there is provided a non-transient computer readable storage medium having computer program instructions stored therein. The computer program instructions, when being executed causes a machine to execute the method as disclosed according to the first aspect of the present disclosure.

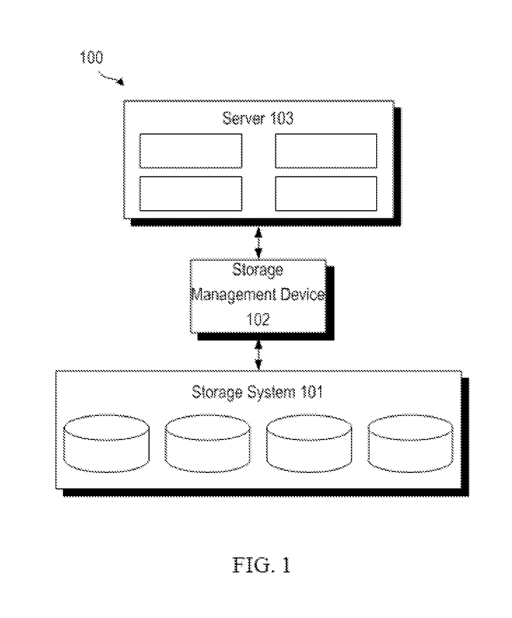

Reference is first made to FIG. 1 which shows a schematic diagram of a system 100 in which embodiments of the present disclosure may be implemented.

As illustrated in FIG. 1, the exemplary system 100 may comprise a storage system 101. The storage system 101 may comprise a plurality of storage arrays, wherein each storage array includes one or more storage devices. According to embodiments of the present disclosure, the storage devices in the exemplary storage system 100 (referred to as storage system or system) may be storage media having different features such as performance, cost, capacity, etc. For example, the storage devices may be SSDs, FC disks, SATA disks or SAS disks, etc.

The exemplary system 100 in FIG. 1 may comprise a storage management device 102 that may be configured to manage storage devices.

According to embodiments of the present disclosure, the storage management device 102 may create storage volumes based on the storage devices included in the storage arrays. One storage volume may correspond to one or more storage devices, or alternatively one storage volume may correspond to one portion of one storage device or a plurality of portions of a plurality of storage devices. To create a storage volume corresponding to a plurality of portions of a plurality of storage devices, then according to embodiments of the present disclosure, these storage devices may have similar features. For example, they may all be SSDs with high performances.

According to embodiments of the present disclosure, the storage management device 102 may classify the storage volumes into a plurality of storage pools based on the features of the storage device. According to embodiments of the present disclosure, the storage volumes corresponding to the storage devices with the same performance may be classified into the same storage pool. For example, it may be possible to classify the storage volume corresponding to the SSD into a high-performance storage pool, classify the storage volume corresponding to the FC disk into a medium-performance storage pool, and classify the storage volume corresponding to the SATA disk into a low-performance storage pool, and so on.

According to embodiments of the present disclosure, based on the service level requirement of storage, the storage management device 102 may create extents from storage pools, and then combine the created extents as a virtual storage volume for use by the server.

Thus, one virtual storage volume may correspond to a plurality of storage devices in different storage arrays. Such a virtualized manner may eliminate physical boundaries between different storage devices so that information movement and access may no longer be limited by physical storage devices, and may be performed over the system 100 between different storage devices in different storage arrays.

According to embodiments of the present disclosure, the storage management device 102 may create storage tiers according to a plurality of storage pools and based on the feature information of the storage devices. For example, a plurality of storage pools including the storage devices with the same performance are combined into a storage tier, or alternatively a plurality of portions of the plurality of storage pools may be combined into a storage tier so that the combined storage tier may have the same performance. This enables the storage tier to correspond to the required feature information of the storage devices, and may be distributed across a plurality of storage arrays, but may not be limited to within a certain storage array.

The system 100 as shown in FIG. 1 may further comprise one or more servers. As described above, the data stored on a plurality of storage arrays may be shared between a plurality of servers via the storage management device 102.

In some descriptions below, some embodiments of the present disclosure will be discussed in the context of the system 100 as shown in FIG. 1. However, it should be noted that as it may be understood for those skilled in the art that this may be merely for the purpose of clear illustration, but not intended to limit the scope of the present disclosure in any manner. On the contrary, embodiments of the present disclosure may be applied to any system, to which the storage system comprising storage arrays can be adapted, that has existed previously and may be developed in future.

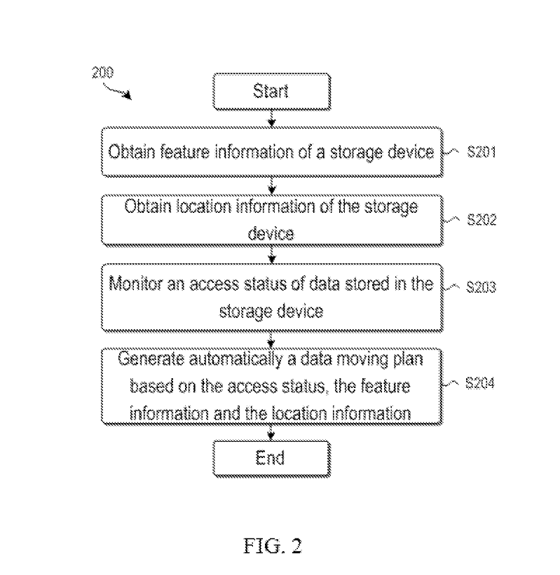

Reference is now made to FIG. 2, which illustrates an exemplary flowchart of a method 200 for automatically relocating data in a plurality of storage arrays according to one embodiment of the present disclosure.

As illustrated in FIG. 2, after method 200 starts, feature information of a plurality of storage devices included in a plurality of storage arrays may be obtained at step S201, wherein the plurality of storage devices are grouped into a plurality of storage tiers based on the feature information. As described above, the feature information may comprise information such as performance, cost, capacity, etc.

According to one embodiment of the present disclosure, the storage devices may be grouped into a plurality of storage tiers based on the feature information of the storage devices according to the manner as described above with reference to the storage management device 102 in the system 100. As described above, such a grouping process from a storage device to a storage tier enables the storage tier to correspond to the feature information of the storage device, and to be distributed across a plurality of storage arrays, without being limited to within a certain storage array. However, as it may be understood for those skilled in the art that the grouping process of the storage device to the storage tier based on the feature information of the storage device may be performed in any other ways, and the scope of the present disclosure is not limited in this regard.

Then, at step S202, location information of a plurality of storage devices included in a plurality of storage arrays may be obtained, and the location information comprises the storage tier and storage array at which a respective storage device is located.

Next, at step S203, an access status of data stored in the plurality of storage devices may be monitored. According to embodiments of the present disclosure, the access may comprise an I/O access.

Then, at step S204, a data moving/movement plan may be automatically generated based on the access status of data, the performance information of the storage device, and the location information of the storage device, and the data moving plan indicates a target location to which the data may be moved.

According to embodiments of the present disclosure, if certain data may be frequently accessed, then the data may be moved to a storage tier with higher performance. Since the storage tier may not be limited to within a certain storage array, such a storage tiering method may be automatically implemented across the storage arrays, thereby not only enabling both of the improvement of storage performance and the reduction of TCO, but also avoiding waste of time and human resources that may be caused by manual tiering operations.

According to one embodiment of the present disclosure, alternatively, the feature information of the storage device obtained at step S201 and the location information of the storage device obtained at step S202 may be preset by a user.

According to one embodiment of the present disclosure, alternatively, the target location indicated by the data moving plan at step S204 may comprise a target storage tier, a target storage array and a target storage device so that the data may be moved to different storage devices in different storage arrays.

In one embodiment of the present disclosure, the above operation of monitoring an access status of data stored in a plurality of storage devices included in a plurality of storage arrays as performed at step S203 may comprise the following: monitoring an input and/or output request for specific data stored in the plurality of storage devices; and based on the monitored input and/or output request, making statistics (statistical analysis to generate statistical data) of the number of accesses to the specific data within a predetermined period of time. According to embodiments of the present disclosure, alternatively, the predetermined period of time may be set by the user, e.g. 24 hours. Then, at step S204, the data moving plan regarding the specific data may be automatically generated based on the number of accesses to the specific data, and the feature information and location information of the storage device. Thus, hot data having frequent I/O requests may be moved to a storage tier with higher performance.

According to one embodiment of the present disclosure, the operation of generating a data moving plan at step S204 may further be performed based on a user predefined policy.

In one embodiment of the present disclosure, the policy may for example comprise a threshold rate between an amount of data stored in a respective storage tier in the plurality of storage arrays and a total amount of data stored in the plurality of storage arrays. For example, alternatively, the user may predefine the threshold rate as indicated below: a high-performance storage tier is allowed to store data occupying 20% of the total amount of data; a medium-performance storage tier is allowed to store data occupying 50% of the total amount of data; and a low-performance storage tier is allowed to store data occupying 100% of the total amount of data.

In one embodiment of the present disclosure, if the rate between the amount of data currently stored in the storage tier where the data may be moved and the total amount of data has reached or exceeded the user predefined threshold rate, then data may not be moved. Alternatively, in one embodiment of the present disclosure, it may be possible to generate a new data moving plan to indicate moving data to a further storage tier. For example, it may indicate moving data to the storage tier with relatively poor performance.

According to embodiments of the present disclosure, method 200 may further comprise, when data is moved based on the data moving plan, monitoring a rate between the amount of data that have been stored in a target storage tier to which the data may be moved and the total amount of data stored in a plurality of storage arrays; in response to the rate exceeding the threshold rate corresponding to the target storage tier, generating a new data moving plan to indicate moving at least part of the data in the target storage tier to a further storage tier. In one embodiment of the present application, for example, the remaining data may be moved to the storage tier having relatively poor performance.

In another embodiment of the present disclosure, the user predefined policy based on which the data moving plan may be generated at step S204 may further comprise a data moving rate. Thus, it may be possible to rationally control and manage the use of bandwidth.

In a further embodiment of the present application, the user predefined policy may further comprise a preferred data relocation time. For example, optionally, the user may predefine performing data relocation in a period of time in which the data reading and writing operations may not be relatively frequent, e.g. 2:00 am. Correspondingly, data moving may be performed based on the preferred time predefined by the user. However, as it may be understood by those skilled in the art, the user may select any appropriate data relocation time based on actual needs, and the scope of the present disclosure may not be limited in this regard.

According to embodiments of the present disclosure, the exemplary method 200 shown in FIG. 2 may further comprise data moving related steps (not shown).

According to one embodiment of the present disclosure, in the method 200, if according to the data moving plan, data need to move from a first storage device in a first storage array to a second storage device in a second storage array, then it may be possible to enable the data to move directly from the first storage device in the first storage array to the second storage device in the second storage array. Supposing that the two storage arrays support the same data replication protocol, and there may be a connection path between them. The path may be a physical, direct connection path, or alternatively may be an indirect connection path via a network, switch or the like.

According to another embodiment of the present disclosure, alternatively, if the two storage arrays do not support the same data replication protocol, or there may be no direct or indirect connection path between them, then it may be possible to receive data to be moved, from the first storage device in the first storage array, and then to send the data to the second storage device in the second storage array. In this case, according to embodiments of the present disclosure, in order to reduce the extra overhead caused by data moving, it may be possible to execute data moving in a predetermined period of time and at a predetermined rate. In embodiments of the present disclosure, the predetermined period of time and rate may be preset by the user.

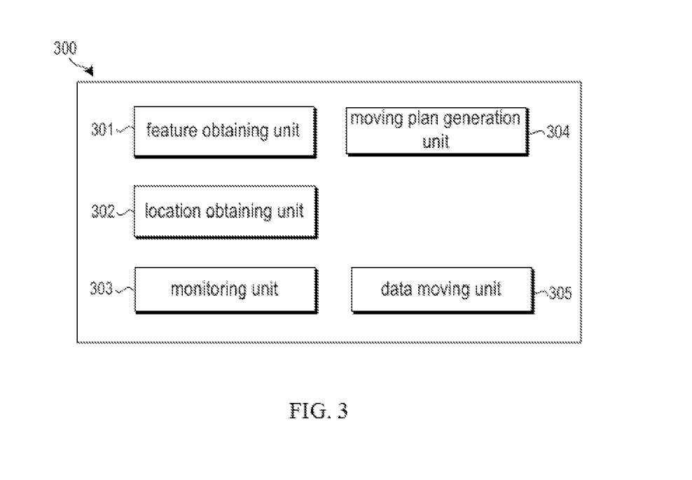

There is described above with reference to FIG. 2 the method for automatically relocating data in a plurality of storage arrays according to embodiments of the present disclosure, and now there is described with reference to FIG. 3 an apparatus capable of executing the above method 200.

FIG. 3 shows a block diagram of an exemplary apparatus 300 for automatically relocating data in a plurality of storage arrays.

The apparatus 300 as shown in FIG. 3 comprises a feature obtaining unit 301, a location obtaining unit 302, a monitoring unit 303 and a moving plan generation unit 304. In one embodiment of the present disclosure, the feature obtaining unit 301, the location obtaining unit 302, the monitoring unit 303, the moving plan generation unit 304 and data moving unit 305 may be combined into a single configuration unit (not shown in Figure), which can collectively perform the tasks associated with each of these unit in a predefined order for automatically relocating data in a plurality of storage arrays. Any further sub-units associates with each of these units may be combined into the configuration unit itself. In one embodiment of the present disclosure, the feature obtaining unit 301 may obtain feature information of a plurality of storage devices included in a plurality of storage arrays, wherein the plurality of storage devices are grouped into a plurality of storage tiers based on the feature information. The location obtaining unit 302 may obtain location information of the plurality of storage devices, the location information including a storage tier and a storage array at which a respective storage device is located. The monitoring unit 303 may monitor an access status of data stored in the plurality of storage devices. The moving plan generation unit 304 may automatically generate a data moving plan based on the access status, the feature information and the location information, the data moving plan indicating a target location to which the data may be moved.

In one embodiment of the present disclosure, the monitoring unit 303 may further monitor an input and/or an output request for specific data stored in the plurality of storage devices included in the plurality of storage arrays, and based on the monitored input and/or output request, generate statistics of the number of accesses to the specific data within a predetermined period of time. The moving plan generation unit 304 may further automatically generate the data moving plan regarding the specific data based on the number of accesses and the feature information and location information of the storage devices.

In one embodiment of the present disclosure, the moving plan generation unit 304 may further generate the data moving plan based on a user predefined policy.

In one embodiment of the present disclosure, the user predefined policy may include a threshold rate between an amount of data stored in a respective storage tier in the plurality of storage arrays and a total amount of data stored in the plurality of storage arrays. The monitoring unit 303 may further monitor a rate between the amount of data that have been stored in a target storage tier to which the data may be moved and the total amount of data when the data is being moved based on the data moving plan. The moving plan generation unit 304 may be further configured to, in response to the rate between the amount of data and the total amount of data exceeding a threshold rate corresponding to the target storage tier, generate a new data moving plan to indicate moving at least part of the data in the target storage tier to a further storage tier.

In one embodiment of the present disclosure, the apparatus 300 may further comprise a data moving unit 305. The data moving unit 305 may enable, according to the data moving plan, the data to move directly from a first storage device in a first storage array to a second storage device in a second storage array, or alternatively may receive data to be moved, from a first storage device in a first storage array, and send the data to a second storage device in a second storage array.

According to embodiments of the present disclosure, the apparatus 300 as shown in FIG. 3 may be implemented in the storage management device 102 as shown in FIG. 1. Alternatively, the apparatus 300 may further be implemented as a separate apparatus separated from the storage management device 102. The scope of the present disclosure may not be limited in this regard.

It should be understood that respective units recited in the apparatus 300 respectively correspond to respective steps in the method 200 as described with reference to FIG. 2, or as illustrated above respective units may be combined in the configuration unit for automatically relocating data in a plurality of storage arrays Thus, the operations and features described above in conjunction with FIG. 2 are also adapted to the apparatus 300 and the units contained therein, and have the same effects. The specific details are on longer repeated.

Exemplary embodiments of the present disclosure are described above with reference to the flowchart of the method and the block diagram of the apparatus. It should be understood that the function and/or apparatus represented by each block in the flowchart and the block diagram may be implemented by means of hardware, for example, an Integrated Circuit (IC), an Application-Specific Integrated Circuit (ASIC), a general-purpose integrated circuit, a Field Programmable Gate Array (FPGA), etc.

Alternatively or additionally, part or all of the functions of the present disclosure may further be implemented by computer program instructions. For example, embodiments of the present disclosure comprise a non-transient computer readable storage medium having stored thereon computer program instructions that, when being executed, enable a machine to perform the steps of the method 200 as described above. Such a computer readable storage medium may comprise a magnetic storage medium such as a hard disk drive, a floppy disk, a tape, etc., an optical storage medium such as an optical disk, etc., and a volatile or non-volatile memory device such as an Electrically Erasable Programmable Read-Only Memory (EEPROM), a Read Only Memory (ROM), a Programmable Read-Only Memory (PROM), a Random Access Memory (RAM), a Dynamic Random Access Memory (DRAM), a Static Random Access Memory (SRAM), a flash memory, a firmware, a programmable logic, etc. The compute program instructions may be loaded to a general-purpose computer, a special-purpose computer or other programmable data processing devices so that the instructions, when being executed by the computer or other programmable data processing devices, may generate means for executing the functions specified in the blocks in the flowchart. The computer program instructions may be written by one or more program design languages or a combination thereof.

Although operations are illustrated in a specific order in the accompanying drawings, it should not be understood as, in order to obtain a desired result, it is necessary to perform these operations in the specific order as illustrated or sequentially, or it is necessary to perform all operations. In some cases, multitask or parallel processing may be beneficial.

Respective embodiments of the present disclosure have been described for the purpose of illustration, but the present disclosure is not intended to be limited to these disclosed embodiments. Without departure from the essence of the present disclosure, all modifications and changes fall into the protection scope of the present disclosure defined by the claims.

What is claimed is:

1. A method for relocating data in a plurality of storage arrays including a plurality of storage devices, the method comprising:
obtaining feature information of a plurality of storage devices, wherein the plurality of storage devices are grouped into a plurality of storage tiers based on the feature information;
obtaining location information of the plurality of storage devices, the location information including a storage tier and a storage array at which a respective storage device is located;
monitoring an access status of data stored in the plurality of storage devices; and
generating, based on the access status, the feature information, and the location information, a data moving plan indicating a target location to which data is to be moved.

2. The method according to claim 1, further comprising:
monitoring an input and/or output request for a specific data stored in the plurality of storage devices;
compiling, based on the monitored input and/or output request, statistics of a number of accesses to the specific data within a predetermined period of time;
generating, based on the number of accesses, the feature information and the location information, the data moving plan regarding the specific data.

3. The method according to claim 1, wherein the data moving plan is further generated based on a user predefined policy.

4. The method according to claim 3, wherein the user predefined policy includes a threshold rate between an amount of data stored in a respective storage tier and a total amount of data stored in the plurality of storage arrays.

5. The method according to claim 4, further comprising:
monitoring a rate between the amount of data that have been stored in a target storage tier to which the data is being moved and the total amount of data, when data is being moved based on the data moving plan; and
in response to the rate exceeding the threshold rate corresponding to the target storage tier, generating a new data moving plan to indicate moving at least part of the data in the target storage tier to a further storage tier.

6. The method according to claim 3, wherein the user predefined policy includes at least one of a data moving rate or a preferred data relocation time.

7. The method according to any of claims 1, further comprising:
moving, according to the data moving plan, the data directly from a first storage device in a first storage array to a second storage device in a second storage array.

8. The method according to any of claims 1, further comprising:
receiving, according to the data moving plan, from a first storage device in a first storage array the data to be moved; and
sending the data to a second storage device in a second storage array.

9. The method according to any of claims 1, wherein the target location includes a target storage tier, a target storage array and a target storage device.

10. The method according to any of claims 1, wherein the feature information and the location information are preset by a user.

11. An apparatus for automatically relocating data in a plurality of storage arrays including a plurality of storage devices, the apparatus comprising:
a configuration unit configured to:
obtain feature information of the plurality of storage devices, wherein the plurality of storage devices are grouped into a plurality of storage tiers based on the feature information;
obtain location information of the plurality of storage devices, the location information including a storage tier and a storage array at which a respective storage device is located;
monitor an access status of data stored in the plurality of storage devices; and
based on the access status, the feature information, and the location information, generate a data moving plan indicating a target location to which the data is be moved.

12. The apparatus according to claim 11, wherein the configuration unit is further configured to
monitor an input and/or output request for a specific data stored in the plurality of storage devices, and based on the monitored input and/or output request,
generate statistics of the number of accesses to the specific data within a predetermined period of time; and
based on the number of accesses of the feature information and of the location information, generate the data moving plan regarding the specific data.

13. The apparatus according to claim 11, wherein the moving plan is generated based on a user predefined policy.

14. The apparatus according to claim 13, wherein the user predefined policy includes a threshold rate between an amount of data stored in a respective storage tier and a total amount of data stored in the plurality of storage arrays.

15. The apparatus according to claim 14, wherein when data is moved based on the data moving plan, monitor a rate between the amount of data that have been stored in a target storage tier to which the data is being moved and the total amount of data; and
in response to the rate between the amount of data and the total amount of data exceeding the threshold rate corresponding to the target storage tier, generate a new data moving plan to indicate moving at least part of the data in the target storage tier to a further storage tier.

16. The apparatus according to claim 13, wherein the user predefined policy includes at least one of a data moving rate or a preferred data relocation time.

17. The apparatus according to any of claims 11, further comprising:
according to the data moving plan, moving the data directly from a first storage device in a first storage array to a second storage device in a second storage array.

18. The apparatus according to any of claims 11, further comprising:
according to the data moving plan, receive, from a first storage device in a first storage array the data to be moved, and send the data to a second storage device in a second storage array.

19. The apparatus according to any of claims 11, wherein the target location includes a target storage tier, a target storage array and a target storage device, or the feature information and the location information are preset by a user

20. A non-transient computer readable storage medium having computer program instructions stored therein for relocating data in a plurality of storage arrays including a plurality of storage device, the computer program instructions, when being executed, causing a machine to execute:
obtaining feature information of a plurality of storage devices, wherein the plurality of storage devices are grouped into a plurality of storage tiers based on the feature information;
obtaining location information of the plurality of storage devices, the location information including a storage tier and a storage array at which a respective storage device is located;
monitoring an access status of data stored in the plurality of storage devices; and
generating, based on the access status, the feature information, and the location information, a data moving plan indicating a target location to which data is to be moved.
